(19) United States
(12) Patent Application Publication
(10) Pub. No.: US 2026/0190069 A1
(43) Pub. Date: Jul. 2, 2026

(54) DATA COLLECTION FOR POSITIONING

(71) Applicant: Telefonaktiebolaget LM Ericsson (publ), Stockholm (SE)

(72) Inventors: Jingya LI, STENBOCKSGATAN (SE); Daniel CHEN LARSSON, LUND (SE); Jung-Fu CHENG, FREMONT, CA (US); Roy TIMO, KUNGSÄNGEN (SE); Yufei BLANKENSHIP, KILDEER, IL (US); Florent MUNIER, VÄSTRA FRÖLUNDA (SE)

(73) Assignee: Telefonaktiebolaget LM Ericsson (publ), Stockholm (SE)

(21) Appl. No.: 19/127,559

(22) PCT Filed: Nov. 6, 2023
(86) PCT No.: PCT/SE2023/051123

§ 371 Date: May 6, 2025

Related U.S. Application Data
(60) Provisional application No. 63/423,393, filed on Nov. 7, 2022.

(51) Int. Cl. H04W 64/00; H04B 17/318; H04L 5/00; H04W 24/10

(52) U.S. Cl. CPC H04W 64/00; H04B 17/328; H04L 5/0051; H04W 24/10

(57) ABSTRACT

An entity in a communications network can receive an uplink (“UL”) measurement message from a first network node. The entity can receive a ground-truth message from a second network node. The entity can assemble a data set associated with a position of a communication device based on the UL measurement message and the ground-truth message.

### TECHNICAL FIELD

The present disclosure is related to communication systems, entities, network nodes, and host for data collection for positioning.

### BACKGROUND

FIG. 1 illustrates an example of a New Radio (“NR”) network (e.g., a 5th Generation (“5G”) network) including a 5G Core (“5GC”) network 130, network nodes 120 a-b (e.g., 5G base station (“gNB”)), multiple communication devices 110 (also referred to as user equipment (“UE”)).

Artificial Intelligence (“AI”) and Machine Learning (“ML”) have been investigated as promising tools to optimize the design of air-interface in wireless communication networks. Example use cases include using autoencoders for channel state information (“CSI”) compression to reduce the feedback overhead and improve channel prediction accuracy; using deep neural networks for classifying line of sight (“LOS”) and non-LOS (“NLOS”) conditions to enhance the positioning accuracy; and using reinforcement learning for beam selection at the network side and/or the UE side to reduce the signaling overhead and beam alignment latency; using deep reinforcement learning to learn an optimal precoding policy for complex multiple-input multiple-output (“MIMO”) precoding problems.

The third generation partnership project (“3GPP”) TS 38.843 release 18 has begun a study of AI/ML for NR air. This study item will explore the benefits of augmenting the air-interface with features enabling improved support of AI/ML based algorithms for enhanced performance and/or reduced complexity/overhead. Through studying a few selected use cases (CSI feedback, beam management and positioning), this study item aims at laying the foundation for future air-interface use cases leveraging AI/ML techniques.

### SUMMARY

According to some embodiments, a method of operating an entity in a communications network is provided. The method includes receiving an uplink (“UL”) measurement message from a first network node. The method further includes receiving a ground-truth message from a second network node. The method further includes assembling a data set associated with a position of a communication device based on the UL measurement message and the ground-truth message.

According to other embodiments, a network node, a communication device, a computer program, a computer program product, a host, or a system are provided to perform the above method.

Certain aspects of the disclosure and their embodiments may provide technical advantages. In some embodiments, several interfaces are provided through which positioning-related information can be exchanged for the purpose of data collection. The proposed messages and interfaces enable labelled data to be collected for training network-side AI/ML-based positioning procedures.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an example of a 5th generation (“5G”) network;

FIG. 2 is a flow chart illustrating an example of a function framework of model LCM for AI on PHY;

FIG. 3 is a block diagram illustrating an example of a positioning architecture for a next generation radio access network (“NG-RAN”);

FIG. 4 is a schematic diagram illustrating an example of positioning signal flows in a multi-user multi-cell network;

FIG. 5 is a table illustrating an example of supported versions of UE positioning procedures;

FIG. 6 is a table illustrating an example of categories of AI/ML procedures for positioning in accordance with some embodiments;

FIG. 7 is a schematic diagram illustrating an example of data collection via a LMF in accordance with some embodiments;

FIG. 8 is a schematic diagram illustrating an example of data collection via both a LMF and a gNB-CU in accordance with some embodiments;

FIG. 9 is a schematic diagram illustrating an example of data collection via a gNB-CU in accordance with some embodiments;

FIG. 10 is a schematic diagram illustrating an example of data collection via both the LMF and a gNB-DU in accordance with some embodiments;

FIG. 11 is a schematic diagram illustrating an example of data collection via the gNB-DU in accordance with some embodiments;

FIG. 12 is a flow chart illustrating an example of operations performed by an entity in accordance with some embodiments;

FIG. 13 is a block diagram of a communication system in accordance with some embodiments;

FIG. 14 is a block diagram of a user equipment in accordance with some embodiments

FIG. 15 is a block diagram of a network node in accordance with some embodiments;

FIG. 16 is a block diagram of a host, which may be an embodiment of the host of FIG. 13, in accordance with some embodiments;

FIG. 17 is a block diagram of a virtualization environment in accordance with some embodiments; and

FIG. 18 shows a communication diagram of a host communicating via a network node with a user equipment over a partially wireless connection in accordance with some embodiments.

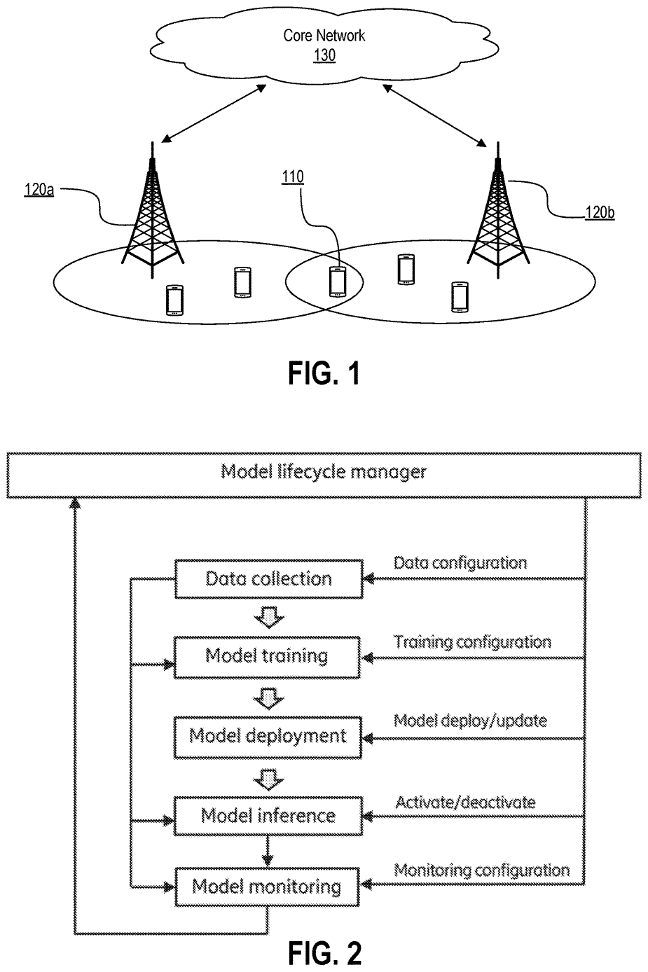

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Artificial intelligence (“AI”)/machine learning (“ML”) model life cycle management (“LCM”) is described below and illustrated in FIG. 2. Data Collection is a stage that collects and provides input data (e.g., raw data or pre-processed data) for AI model training, inference, and monitoring. AI/ML algorithm specific data preparation (e.g., data ingestion and data refinement) is not carried out in the Data Collection stage.

Model Training is a process that uses featured data in terms of training datasets and validation datasets to train an AI/ML model.

Model deployment is a process of converting an AI/ML model into an executable form with delivery it to a target UE for inference where model inference is to be performed.

Model inference is a process of using a deployed AI/ML model to produce a set of outputs based on a set of featured inputs.

Model monitoring is a process that monitoring drifts in data and model or monitoring performance metrics after the model has been deployed. Based on the monitored performance, decisions like model activation/deactivation/switching/fallback/selection can be taken.

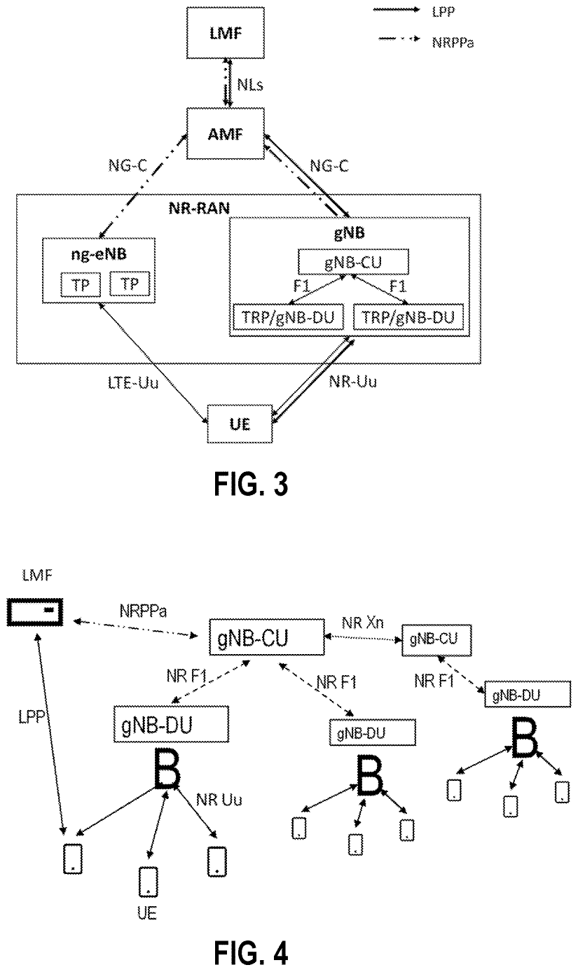

An example of an architecture for NR positioning is illustrated in FIGS. 3-4.

FIG. 3 illustrates an example that the NR Rel-16 positioning architecture for next generation radio access network (“NG-RAN”). This architecture is capable of positioning a UE with NR gNB transmission reception points (“TRPs”) or long term evolution (“LTE”) ng-eNB access with transmission points (TPs).

FIG. 4 illustrates an example of positioning signalling flows in a multi-user multi-cell network, without showing all the detailed interfaces and entities involved in the positioning system.

The gNB can be split into two functionalities: a central unit (“gNB-CU”) and distributed units (“gNB-DUs”). The gNB-CU and gNB-DU communicate via the F1 interface. The gNB-DUs hos the TRPs. A single gNB-CU may connect to one or more gNB-DUs.

A positioning entity, called the location management function (“LMF”), is responsible for computing the UE's location. The LMF receives measurements and assistance information from the NG-RAN and the UE via the access and mobility management function (“AMF”) over the NLs interface. The NR positioning protocol A (“NRPPa”) protocol is used to carry the positioning information between NG-RAN and LMF.

The LMF configures the UE using the extended LTE positioning protocol (“LPP”) via the AMF. As shown in FIG. 3, both the NRPPa and the LPP protocols are transported over the control plane of the NG interface via the AMF.

In the description of some embodiments herein, the AMF node is omitted for brevity when illustrating the signalling between the UE and LMF and the NG-RAN (e.g., gNB) and LMF. However, omitting the AMF node does not limit the scope of the innovations. The proposed innovations can be applied using the existing NR positioning protocol with AMF connecting the NG-RAN and LMF.

The LMF can retrieve positioning related measurements directly from the UE via the LPP protocol, when using UE-based positioning procedures such as downlink observed time difference of arrival (“DL-OTDOA”) and downlink angle of departure (“DL-AoD”). The UE reports positioning related radio measurement results to the LMF using LPP.

For uplink (“UL”) sounding reference signal (“SRS”)-based positioning procedures, the SRS transmission of a UE is configured by its serving gNB. In some examples, the serving gNB signals the SRS transmission configuration to the UE via RRC signalling. In additional or alternative examples, the gNB signals the SRS configuration to the LMF using NRPPa.

The LMF forwards the SRS configuration to other TRPs so that they can perform measurements on the SRS. The SRS measurement results are sent from each TRP to LMF using NRPPa. The gNB reports positioning related radio measurement results (e.g., based on the configured SRS) to the LMF using the NRPPa.

A LMF is described further below. The LMF is responsible for managing the support of different location services for target UEs, including positioning of UEs and delivery of assistance data to UEs. To obtain position measurements for the target UE, the LMF may interact with the UE's serving gNB (or ng-eNB). This interaction may involve the exchange of uplink measurements made by an NG-RAN and downlink measurements made by the UE. These measurements may have been provided to an NG-RAN as part of other functions such as for support of handover.

The LMF may interact with a target UE to deliver assistance data when requested by a location service.

The LMF may interact with multiple NG-RAN nodes to provide assistance data information for broadcasting. The assistance data information for broadcast may optionally be segmented and/or ciphered by the LMF. The LMF may also interact with AMFs to provide ciphering key data information to the AMF.

For positioning of a target UE, the LMF decides on the position procedures to be used, based on factors that may include the location service (“LCS”) Client type, the required quality of service (“QoS”), UE positioning capabilities, gNB/ng-eNB positioning capabilities. The LMF invokes selected positioning procedures in the UE and/or serving gNB and/or serving ng-eNB. The positioning procedures may yield a location estimate for UE-based position procedures and/or positioning measurements for UE-assisted and network-based position procedures. The LMF may combine all the received results and determine a single location estimate for the target UE (hybrid positioning). Additional information like accuracy of the location estimate and velocity may also be determined.

The LMF may interact with the AMF to provide (updated) UE Positioning Capability to AMF and to receive stored UE Positioning Capability from AMF.

A F1 interface is described below. In case of split gNB architecture, the F1 interface is used to support the exchange of positioning information between the gNB-DU and the gNB-CU; it is also used transparently as a transport link for the LPP.

The LPP is described below. The LPP is terminated between a target device (the UE in the control-plane case or SET in the user-plane case) and a positioning server (the LMF in the control-plane case or SLP in the user-plane case). It may use either the control-or user-plane protocols as underlying transport. In this specification, only control plane use of LPP is defined.

LPP messages are carried as transparent PDUs across intermediate network interfaces using the appropriate protocols (e.g., NGAP over the NG-C interface, NAS/RRC over the LTE-Uu and NR-Uu interfaces). The LPP protocol is intended to enable positioning for NR and LTE using a multiplicity of different position procedures, while isolating the details of any particular positioning procedure and the specifics of the underlying transport from one another.

The protocol operates on a transaction basis between a target device and a server, with each transaction taking place as an independent procedure. More than one such procedure may be in progress at any given moment. An LPP procedure may involve a request/response pairing of messages or one or more “unsolicited” messages. Each procedure has a single objective (e.g., transfer of assistance data, exchange of LPP related capabilities, or positioning of a target device according to some QoS and use of one or more positioning procedures). Multiple procedures, in series and/or in parallel, can be used to achieve more complex objectives (e.g., positioning of a target device in association with transfer of assistance data and exchange of LPP related capabilities). Multiple procedures also enable more than one positioning attempt to be ongoing at the same time (e.g., to obtain a coarse location estimate with low delay while a more accurate location estimate is being obtained with higher delay).

An LPP session is defined between a positioning server and the target device. LPP defined data structures for assistance data information are reused for supporting RRC broadcast of assistance data information which are embedded in positioning SIBs. This enables broadcast assistance data using the same data structures which are used for point-to-point location.

A NRPPa is described below. The NRPPa carries information between the NG-RAN Node and the LMF. In some examples, the NRPPa is used to support E-CID for E-UTRA where measurements are transferred from the ng-eNB to the LMF. In additional or alternative examples, the NRPPa is used to support data collection from ng-eNB's and gNB's for support of OTDOA positioning for E-UTRA. In additional or alternative examples, the NRPPa is used to support Cell-ID and Cell Portion ID retrieval from gNB's for support of NR Cell ID positioning procedure. In additional or alternative examples, the NRPPa is used to support exchange of information between LMF and NG-RAN node for the purpose of assistance data broadcasting. In additional or alternative examples, the NRPPa is used to support NR E-CID where measurements are transferred from the gNB to the LMF. In additional or alternative examples, the NRPPa is used to support NR Multi-RTT where measurements are transferred from the gNB to the LMF. In additional or alternative examples, the NRPPa is used to support NR UL-AoA where measurements are transferred from the gNB to the LMF. In additional or alternative examples, the NRPPa is used to support NR UL-TDOA where measurements are transferred from the gNB to the LMF. In additional or alternative examples, the NRPPa is used to support Data collection from gNBs for support of DL-TDOA, DL-AOD, Multi-RTT, UL-TDOA, UL-AoA.

The NRPPa protocol is transparent to the AMF. The AMF routes the NRPPa PDUs transparently based on a Routing ID corresponding to the involved LMF over NG-C interface without knowledge of the involved NRPPa transaction. It carries the NRPPa PDUs over NG-C interface either in UE associated mode or non-UE associated mode.

In case of a split gNB architecture, the NRPPa protocol is terminated at the gNB-CU.

A UE is described below. The UE may make measurements of downlink signals from NG-RAN and other sources such as E-UTRAN, different GNSS and TBS systems, WLAN access points, Bluetooth beacons, UE barometric pressure and motion sensors. The measurements to be made will be determined by the chosen positioning procedure.

The UE may also contain LCS applications or access an LCS application either through communication with a network accessed by the UE or through another application residing in the UE. This LCS application may include the needed measurement and calculation functions to determine the UE's position with or without network assistance. This is outside of the scope of this specification.

The UE may also, for example, contain an independent positioning function (e.g., GPS) and thus be able to report its position, independent of the NG-RAN transmissions. The UE with an independent positioning function may also make use of assistance information obtained from the network.

A Positioning Reference Unit (“PRU”) is described below. A positioning reference unit (PRU) at a known location can perform positioning measurements (e.g., RSTD, RSRP, UE Rx-Tx Time Difference measurements, etc.) and report these measurements to a location server. In addition, the PRU can transmit SRS to enable TRPs to measure and report UL positioning measurements (e.g., RTOA, UL-AoA, gNB Rx-Tx Time Difference, etc.) from PRU at a known location.

The PRU measurements can be compared by a location server with the measurements expected at the known PRU location to determine correction terms for other nearby target devices.

The DL-and/or UL location measurements for other target devices can then be corrected based on the previously determined correction terms.

From a location server perspective, the PRU functionality is realized by a UE with known location.

In some examples, the PRU is viewed as a stationary device that is deployed at a known location within fixed infrastructure. In additional or alternative examples, the PRU is used for calibrating legacy (LTE and NR) positioning solutions. For example, an LMF can estimate ToA and/or AoA offsets/biases for UL-SRS based solutions using a PRU (since it knows the PRU's location).

Standard UE positioning procedures are described below. The standard positioning procedures supported for NG-RAN access include: network-assisted GNSS procedures; observed time difference of arrival (OTDOA) positioning based on LTE signals; enhanced cell ID procedures based on LTE signals; WLAN positioning; Bluetooth positioning; terrestrial beacon system (TBS) positioning; sensor based procedures (e.g., barometric Pressure Sensor and/or motion sensor); NR enhanced cell ID procedures (NR E-CID) based on NR signals; Multi-Round Trip Time Positioning (Multi-RTT based on NR signals); Downlink Angle-of-Departure (DL-AoD) based on NR signals; Downlink Time Difference of Arrival (DL-TDOA) based on NR signals; Uplink Time Difference of Arrival (UL-TDOA) based on NR signals; Uplink Angle-of-Arrival (UL-AoA), including A-AoA and Z-AoA based on NR signals.

In some examples, hybrid positioning using multiple procedures from the above list is also supported. Standalone mode (e.g., autonomous, without network assistance) using one or more procedures from the above list is also supported.

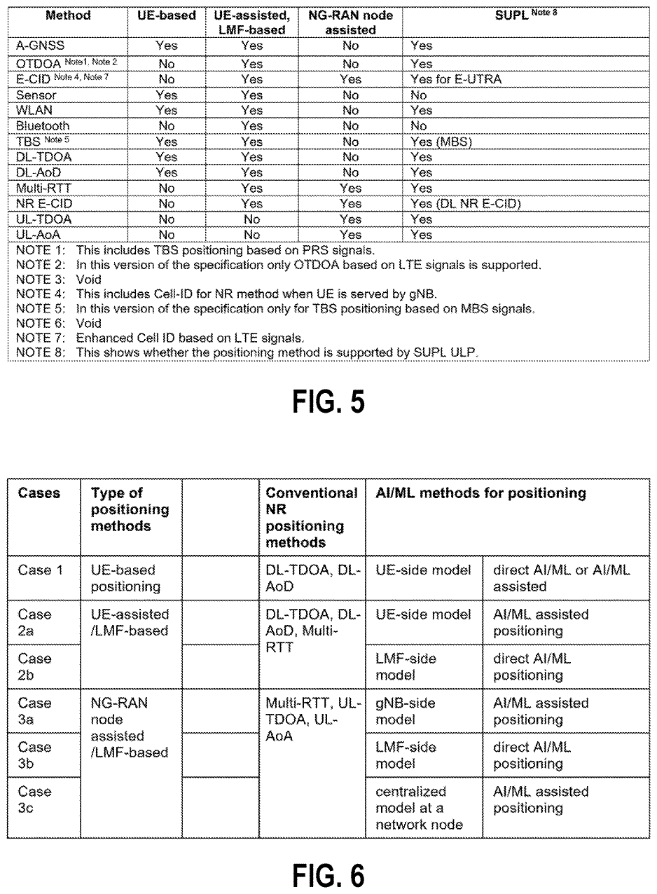

The positioning procedures may be supported in UE-based, UE-assisted/LMF-based, and NG-RAN node assisted versions. FIG. 5 indicates which of these versions are supported in this version of the specification for the standardized positioning procedures.

Sensor, WLAN, Bluetooth, and TBS positioning procedures based on MBS signals are also supported in standalone mode, as described in the corresponding clauses.

Network-assisted global navigation satellite system (“GNSS”) procedures are described below.

GNSS procedures make use of UEs that are equipped with radio receivers capable of receiving GNSS signals. In 3GPP specifications the term GNSS encompasses both global and regional/augmentation navigation satellite system Examples of global navigation satellite systems include GPS, Modernized GPS, Galileo, GLONASS, and BeiDou Navigation Satellite System (“BDS”). Regional navigation satellite systems include Quasi Zenith Satellite System (“QZSS”), and NAVigation with Indian Constellation (“NavIC”).

OTDOA positioning is described below. The OTDOA positioning procedure makes use of the measured timing of downlink signals received from multiple TPs, comprising eNBs, ng-eNBs and PRS-only TPs, at the UE. The UE measures the timing of the received signals using assistance data received from the positioning server, and the resulting measurements are used to locate the UE in relation to the neighboring TPs.

Enhanced Cell ID procedures are described below. In the Cell ID (“CID”) positioning procedure, the position of an UE is estimated with the knowledge of its serving ng-eNB, gNB and cell. The information about the serving ng-eNB, gNB and cell may be obtained by paging, registration, or other procedures.

Enhanced Cell ID (“E-CID”) based on LTE signals positioning refers to techniques which use additional UE measurements and/or NG-RAN radio resource and other measurements to improve the UE location estimate. In the case of a serving ng-eNB, uplink E-CID may be supported based on NR, GERAN, UTRA or WLAN signals.

Although E-CID based on LTE signals positioning may use some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

In cases with a requirement for close time coupling between UE and ng-eNB measurements (e.g., TADV type 1 and UE E-UTRA Rx-Tx time difference), the ng-eNB configures the appropriate RRC measurements and is responsible for maintaining the required coupling between the measurements.

Barometric pressure sensor positioning is described below. The barometric pressure sensor procedure makes use of barometric sensors to determine the vertical component of the position of the UE. The UE measures barometric pressure, optionally aided by assistance data, to calculate the vertical component of its location or to send measurements to the positioning server for position calculation.

This procedure should be combined with other positioning procedures to determine the 3D position of the UE.

WLAN positioning is described below. The WLAN positioning procedure makes use of the WLAN measurements (AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated.

Alternatively, the UE makes use of WLAN measurements and optionally WLAN AP assistance data provided by the positioning server, to determine its location.

Bluetooth positioning is described below. The Bluetooth positioning procedure makes use of Bluetooth measurements (beacon identifiers and optionally other measurements) to determine the location of the UE. The UE measures received signals from Bluetooth beacons. Using the measurement results and a references database, the location of the UE is calculated. The Bluetooth procedures may be combined with other positioning procedures (e.g. WLAN) to improve positioning accuracy of the UE.

TBS positioning is described below. A Terrestrial Beacon System (“TBS”) consists of a network of ground-based transmitters, broadcasting signals only for positioning purposes. The current type of TBS positioning signals are the MBS (Metropolitan Beacon System) signals and Positioning Reference Signals (PRS). The UE measures received TBS signals, optionally aided by assistance data, to calculate its location or to send measurements to the positioning server for position calculation.

Motion sensor positioning is described below. The motion sensor procedure makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This procedure should be used with other positioning procedures for hybrid positioning.

NR Enhanced Cell ID procedures are described below. NR Enhanced Cell ID (NR E-CID) positioning refers to techniques which use additional UE measurements and/or gNB measurements to improve the UE location estimate.

Although NR E-CID positioning may utilise some of the same measurements as the measurement control system in the RRC protocol, the UE generally is not expected to make additional measurements for the sole purpose of positioning; i.e., the positioning procedures do not supply a measurement configuration or measurement control message, and the UE reports the measurements that it has available rather than being required to take additional measurement actions.

Multi-RTT positioning is described below. The Multi-RTT positioning procedure makes use of the UE Rx-Tx time difference measurements (and optionally DL-PRS-RSRP and/or DL-PRS-RSRPP) of downlink signals received from multiple TRPs, measured by the UE and the measured gNB Rx-Tx time difference measurements (and optionally UL-SRS-RSRP and/or UL-SRS-RSRPP) at multiple TRPs of uplink signals transmitted from UE.

The UE measures the UE Rx-Tx time difference measurements (and optionally DL-PRS-RSRP and/or DL-PRS-RSRPP of the received signals) using assistance data received from the positioning server, and the TRPs measure the gNB Rx-Tx time difference measurements (and optionally UL-SRS-RSRP and/or UL-SRS-RSRPP of the received signals) using assistance data received from the positioning server. The measurements are used to determine the RTT at the positioning server which are used to estimate the location of the UE.

DL-AoD positioning is described below. The DL-AoD positioning procedure makes use of the measured DL-PRS-RSRP (and optionally DL-PRS-RSRPP) of downlink signals received from multiple TPs, at the UE. The UE measures the DL-PRS-RSRP (and optionally DL-PRS-RSRPP) of the received signals using assistance data received from the positioning server, and the resulting measurements are used along with other configuration information to locate the UE in relation to the neighboring TPs.

DL-TDOA positioning is described below. The DL-TDOA positioning procedure makes use of the DL RSTD (and optionally DL-PRS-RSRP and/or DL-PRS-RSRPP) of downlink signals received from multiple TPs, at the UE. The UE measures the DL RSTD (and optionally DL-PRS-RSRP and/or DL-PRS-RSRPP) of the received signals using assistance data received from the positioning server, and the resulting measurements are used along with other configuration information to locate the UE in relation to the neighboring TPs.

UL-TDOA positioning is described below. The UL-TDOA positioning procedure makes use of the UL-RTOA (and optionally UL-SRS-RSRP and/or UL-SRS-RSRPP) at multiple RPs of uplink signals transmitted from UE. The RPs measure the UL-RTOA (and optionally UL-SRS-RSRP and/or UL-SRS-RSRPP) of the received signals using assistance data received from the positioning server, and the resulting measurements are used along with other configuration information to estimate the location of the UE.

UL-AoA is described below. The UL-AoA positioning procedure makes use of the measured azimuth angle of arrival (A-AoA) and zenith angle of arrival (Z-AoA) at multiple RPs of uplink signals transmitted from the UE. The RPs measure A-AoA and Z-AoA (and optionally UL-SRS-RSRPP) of the received signals using assistance data received from the positioning server, and the resulting measurements are used along with other configuration information to estimate the location of the UEs.

There currently exist certain challenges. AI/ML-based positioning solutions can achieve good UE positioning accuracy for moderate and heavy non line of sight (“NLOS”) deployments-conditions where existing positioning solutions typically struggle.

However, AI/ML-based positioning solutions need to be trained on well-labelled dataset. For example, a “CIR fingerprinting AI/ML model” may need to be trained on a large CIR dataset where each CIR has a label (e.g., UE location).

For NW-side positioning, it is currently difficult to collect labelled data for the purpose of training AI/ML-based positioning solutions. The relevant data is not confined to a single node-some of the data is known to the LMF, while other parts of the data are known to the gNB, gNB-CU, or gNB-DU.

More specifically, the current NR standard is missing certain interfaces and messages on the NW-side that are needed to enable one or more entities to collect data needed to train AI/ML-based positioning solutions.

Certain aspects of the disclosure and their embodiments may provide solutions to these or other challenges. Various embodiments herein enable a data-collection entity to collect positioning data from an LMF and gNB (gNB-CU and/or gNB-DU). In some embodiments, new messages are introduced that include fields related to the SRS reception and the UE position and interfaces to the data collection entity from the corresponding nodes.

Various embodiments herein are generally associated with data collection for training network (“NW”)-side artificial intelligence (“AI”)/machine learning (“ML”)-based positioning solutions. The collected data, however, can be used for other purposes including, for example, AI/ML model performance monitoring. In some embodiments, the data to be collected for model training include: measurement data, data for ground truth label, and auxiliary data.

In some examples, measurement data corresponds to the model input X. For example, if the model input is channel impulse response (“CIR”), then the measurement data is the CIR obtained from measuring a reference signal (e.g., a sounding reference signal (“SRS”) on the uplink). In addition to the measurement data value, a quality indicator of the measurement data value can be collected, where the quality indicator may be conveyed in various ways including: uncertainty range of the measurement, reliability level of the measurement, confidence level, accuracy estimation, or an estimation of the uplink (“UL”) signal-to-noise ratio (“SNR”). The quality of the measurement data X can be taken into account when perform model training, for example, giving more weights to training data that are associated with higher confidence.

In additional or alternative examples, data for ground truth label corresponds to the model output Y. Ground truth label needs to be collected if the model training is achieved by supervised learning. For unsupervised learning or semi-supervised learning, the ground truth label may not be necessary and can be skipped in data collection. In addition to the value of ground truth label, quality indicator of the ground truth label can be collected as well (e.g., reliability level, confidence level, or accuracy estimation of the collected ground truth label).

Similar to X, the quality of the model output Y can be taken into account when performing model training. For example, for direct AI/ML positioning, the model output is the UE's location coordinates, thus the ground truth label is the UE location (Y) which gives the coordinates where the measurement data (X) is observed. In another example, for AI/ML assisted positioning, the model output is an estimate of an intermediary variable (and not the UE's location) that is used as input to a conventional positioning method such as UL-TDOA. Typical model output may include LOS/NLOS indicator, ToA, TDoA, RSTD, AoD, AoA.

These intermediary variables do not need to correspond to physically observable variables. For example, if LMF knows the gNB and UE location, then it can compute the unobservable ToA for the given UE location assuming there are no blockers. An AI/ML model can then be trained to estimate (fingerprint) the unobserved ToA directly from CIR measurements.

The ground truth messages refers to information that provides the desired ground truth label (e.g., ToA) directly or indirectly needed for training the AI/ML model. In a broad sense, data for ground truth label can include any information that enables the computation of the ground truth label. For example, the UE's location can be used to obtain the distance d between the UE and a TRP, then ToA for a signal between the UE and the TRP can be obtained as d/c, where c is the speed of light. Thus the UE's location can be collected as data for ground truth label when the ground truth label is ToA.

In additional or alternative examples, auxiliary data is used as auxiliary information for building the database of AI/ML training data. For example, the auxiliary data may include: time stamp, UE ID, TRP ID, cell ID (global cell ID or physical cell ID), PLMN, area ID(s) (e.g., one or more registration area identifier(s), tracking area code(s), RAN notification area ID(s), location area ID, or routing area ID), or frequency layer ID.

In some embodiments, training data collection depends on the characteristics of the AI/ML model, including input, output, and where the AI/ML model is located. Here the focus is on AI/ML model at the network side, thus the Cases 2b, 3a, 3b, 3c in the table of FIG. 6.

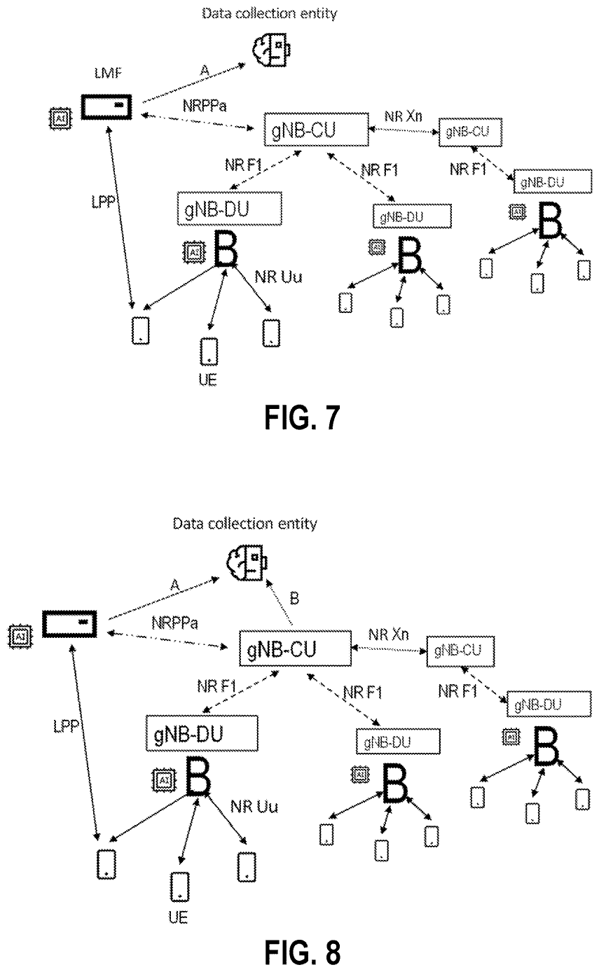

Embodiments regarding collection of data from LMF are described below and an example is illustrated in FIG. 7.

In some embodiments, the data collection is performed via the LMF. In some examples, the LMF collects measurement data from the gNB-CU, where the measurement data corresponds to the AI/ML model input X.

In additional or alternative embodiments, the data collection procedure can be described as follows: (1) the gNB-DU performs measurements on UL SRS; (2) the gNB-DU signals the measurement over the F1 interface to the gNB-CU. The measurements may be compressed or mapped to a standardized format (e.g., a codebook); (3) the gNB-CU signals the measurement data to the LMF over the NRPPa interface. For example, the NRPPa interface may be enhanced to support signaling of CIRs or compressed/standardized representations of the CIRs; and (4) data collected via this route is related to uplink transmissions by the UE. This data can be used as the input to a NW-side AI/ML-based positioning solution.

For NG-RAN node assisted/LMF-based positioning, the measurement is obtained by observing SRS transmission on the uplink. The measurement results included in data collection can include one or more of the fields for multiple SRS receptions. In some examples, the fields for multiple SRS receptions can include UE identification information (e.g., C-RNTI, SRS resource ID together with cell ID and time stamp).

In additional or alternative examples, the fields for multiple SRS receptions can include SRS configuration that UE used to transmit SRS with (e.g., SRS resource ID, SRS resource set ID, Cell ID).

In additional or alternative examples, the fields for multiple SRS receptions can include recorded SRS reception in some form. The recorded SRS reception can include Channel Impulse Response(CIR), Timing of arrival (ToA), Timing difference of arrival (TDoA), angle of departure (AoD), and/or angel of arrival (AoA), and/or received reference signal power (RSRP) of the SRS. The recorded SRS reception can include the estimated channel by the gNB in some form, either compressed or uncompressed. The recorded SRS reception can include Path List of the SRS with either the current format in 38.455 V 17.2.0 or with extended number of paths. The recorded SRS reception can include Carrier phase difference. The recorded SRS reception can include Round-trip time (RTT) measurement. The recorded SRS reception can include the cell ID of the gNB-DU/TPR who performed the measurements. The recorded SRS reception can include carrier frequency. The recorded SRS reception can include carrier bandwidth.

In additional or alternative examples, the fields for multiple SRS receptions can include a quality indicator of the measurement data from SRS reception.

In additional or alternative examples, the fields for multiple SRS receptions can include a timestamp for the SRS reception.

The above message can be referred to as a “gNB measurement message.” The “gNB measurement message” may include information about multiple UEs and by that each field may contain be replicated per UE. The message may also contain information for a UE at multiple time instance.

It should be noted that the SRS configured for data collection for positioning may or may not be a positioning-specific SRS. For example, if the positioning solution is based on SRS measurement results that consists of only RSRP measurements, then, normal SRS can also be used for collection data for this positioning use case.

The LMF further collects information related to the UE ground truth. This information includes one or more of the following fields (which can be referred to as a “LMF collected UE ground truth message”). In some examples, the LMF collected UE ground truth message includes UE identification information (e.g., C-RNTI, SRS resource ID together with cell ID and time stamp).

In additional or alternative examples, the LMF collected UE ground truth message includes a UE ground truth label or position in some form. The position can be in global coordinates or in a relative manner to some fixed location. The ground truth label can include the serving cell ID of the UE. Further the position related information can one or more of: a Timing of arrival (“ToA”) of at a DL signal or a UL signal; a Timing difference of arrival (“TDoA”) of DL signals or UL signals; a DL or UL angle of departure (“AoD”); a DL or UL angle of arrival (“AoA”); a received reference signal power (“RSRP”); a cell ID and TRP related information (e.g., RS resource and/or resource set ID); a carrier phase difference; a round-trip time (“RTT”) measurement; and a timestamp.

Further note that the message ground-truth message may contain information about multiple UEs and by that each field may contain be replicated per UE. The message may also contain information for a UE at multiple time instance.

The LMF receives the message or multiple messages and further combines the information with information of UE position during the time-stamped occasions of the SRS receptions. It should be understood here that there can be some uncertainty in the timestamping between the UE and gNB. Hence the LMF can try to match this as good as possible. After which the LMF will provide in a message or multiple messages on the interface A to a data collection entity. Here, the interface A can be a standardized interface or a proprietary interface. The LMF further combines the messages “LMF collected UE ground truth message” and “gNB measurement message” and sends it to the data collection entity which receives the message. The combination of the message can look, for example, as follows and include at least one or more of the following fields (further referred to as “data collection entity message”). In some examples, the data collection entity message can include UE identification information (e.g., C-RNTI).

In additional or alternative examples, the data collection entity message can include UE ground truth label or position in some form. The position can be in global coordinates, in a relative manner to some fixed location, or in a relative manner to a location map. Further the position related information can one or more of: a ToA of at a DL signal or a UL signal; a TDoA of DL signals or UL signals; a DL or UL AoD; a DL or UL AoA; a RSRP; a Cell ID and TRP related information (e.g., RS resource and/or resource set ID); a carrier phase difference; and a RTT measurement.

In additional or alternative examples, the data collection entity message can include a SRS configuration that UE used to transmit SRS with (e.g., SRS resource ID, SRS resource set ID, cell ID).

In additional or alternative examples, the data collection entity message can include a recorded SRS reception in some form. The exact measurement from SRS reception depends on the model input. The recorded SRS reception can be Channel Impulse Response (“CIR”), ToA, TDoA, AoD, AoA, and/or a RSRP of the SRS. The recorded SRS reception can include the estimated channel by the gNB in some form, either compressed or uncompressed. The recorded SRS reception can include a Path List of the SRS with either the current format in 38.455 V 17.2.0 or with extended number of paths. The recorded SRS reception can include carrier phase difference. The recorded SRS reception can include a RTT measurement.

In additional or alternative examples, the data collection entity message can include a quality indicator of the measurement data from SRS reception.

In additional or alternative examples, the data collection entity message can include a timestamp Further note that the combined message may contain information about multiple UEs and by that each field may contain be replicated per UE. The message may also contain information for a UE at multiple time instance.

The data collection can take place based on a single request message from the data collection entity, i.e. a “one-shot data set” is sent by the LMF in response to a single request message. Alternatively, the data collection entity can send a request message containing reporting parameters consisting of e.g. LMF reporting periodicity (the LMF then send an updated set of data periodically), periodic reporting validity (notifying for how long the LMF is requested to report). The data collection entity can also end periodic reporting by sending a “suspend/terminate” reporting message to the LMF to halt the periodic reporting.

For UE-assisted/LMF-based positioning with LMF-side model, the measurement data is obtained by UE measuring the PRS transmission on the downlink in multiple cells. The measurement data is then sent to the LMF by UE via the LPP messages. Then the data collection entity will receive measurement data from LMF, which corresponds to the model input X for the LMF-side model.

Embodiments associated with collection of data from LMF and gNB-CU are described below and an example is illustrated in FIG. 8.

In some embodiments, the data collection is performed via the LMF and gNB-CU for NG-RAN node assisted/LMF-based positioning. This is illustrated on a high-level in FIG. 8. The basic principle is that the data collection entity collects data from the gNB-CU and the LMF. Starting with the data collected from the gNB-CU. This is done over the interface B (see FIG. 8). Here, the interface B can be a standardized interface or a proprietary interface. The gNB-DU providing message on the F1 interface to the gNB-CU and then the gNB-CU providing it to the data collection entity on interface B. The data collected via this route is data related to UE and specifically related to uplink transmissions. The message that the data collection entity receives and the gNB-CU transmits is the “gNB measurement message”.

Similar criteria can apply to this embodiment as some of the previous embodiments.

The data collection entity further collects the ground truth label. For example, if the ground truth label is UE location, the data collection entity obtains the information from the LMF of the UE location during the time the UE transmit SRS. This information is provided to the data collection entity over interface A, wherein it receives the message “LMF collected UE ground truth message”. Similar criteria for it applies as within the first embodiment.

After the data collection entity has received both messages it can combine them to complete data set, i.e. matching the UEs position with its SRS data. Similar criteria for it applies as within the first embodiment. In some embodiments herein, the term combining can include matching, collecting, or assembling can be used to describe an action of generating or forming a data set from different types and/or sources of data.

In another example, if the ground truth label is an intermediary measurement (e.g., ToA, TDoA, AoA) that corresponds to the ML output of AI/ML assisted positioning methods, the data collection entity obtains the data of ground truth label from gNB-CU and match it with the measurement data. This without collecting information from the LMF. Instead just provide this towards to the data collection entity and without collecting information from the LMF. The gNB-CU can do so for multiple UEs and multiple time instances if the “gNB measurement message” is according to these criteria's.

In another example, the data collection entity may collect simiar data over the interface A (for gNBs connected to the LMF) and over interface B (for gNB not connected to the LMF, but known to the data collection entity).

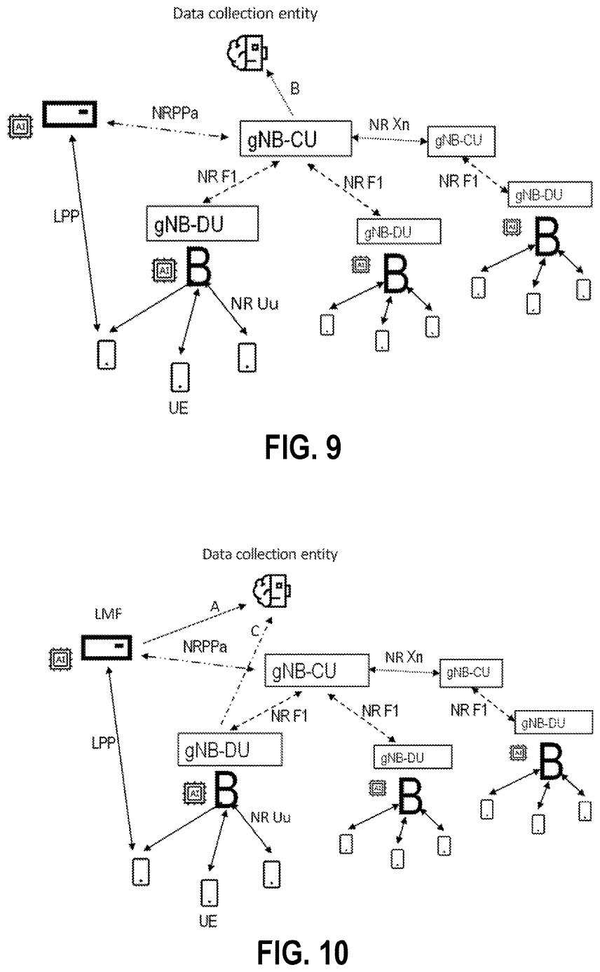

Embodiments associated with collection of data from gNB-CU are described below and an example is illustrated in FIG. 9.

In some embodiments, the data is sent via the gNB-CU for NG-RAN node assisted/LMF-based positioning. This is illustrated on a high-level in FIG. 9. The basic principle is that the gNB-CU collects data from the gNB-DU. The gNB-DU provides it via the F1 interface to the gNB-CU the message UL measurement message. Similar criteria can apply to this embodiment as some of the previous embodiments.

In additional or alternative embodiments, the gNB-CU receives message or messages from the LMF on the NRPPa protocol that corresponds to the ground-truth message. Similar criteria for it applies as within the first embodiment. The ground truth message might be the UE location or the unobserved ToAs (the ideal ToAs for that UE location, assuming no blockers).

The gNB-CU combines the content of the two above set of messages and send the content to the data collection entity over the B interface (see FIG. 9). It should be understood here that there can be some uncertainty in the timestamping between the UE and gNB. Hence the gNB-CU can try to match this as good as possible. After which the gNB-CU will provide in the message “data collection entity message” on the interface A to a data collection. Similar criteria for it applies as within the first embodiment.

Embodiments associated with collection of data from LMF and gNB-DU are described below and an example is illustrated in FIG. 10.

In some embodiments, the data collection for the AI/ML model training is performed via the LMF and gNB-DU. This is illustrated on a high-level in FIG. 10. The basic principle is that the data collection entity collects data from the gNB-DU and the LMF.

Starting with the data collected from the gNB-DU. This is done over the interface C (see FIG. 10) towards the data collection entity. Specifically, the UL measurement message is sent between the gNB-DU and data collection entity. Similar criteria for it applies as the above embodiments.

The data collection entity further collects the information from the LMF of the UE location during the time the UE transmit SRS. This information is provided to the data collection entity over interface A (see FIG. 10) is the ground-truth message. Similar criteria for it applies as within the first embodiment.

After the data collection entity has received both messages it can combine them to complete data set, i.e. matching the UEs position with its SRS data. Similar criteria for it applies as within the first embodiment.

In another example, if the ground truth label is an intermediary measurement (e.g., ToA, TDoA, AoA) that corresponds to the ML output of AI/ML assisted positioning methods, the data collection entity obtains the data of ground truth label from gNB-DU and match it with the measurement data. The gNB-DU can do so for multiple UEs and multiple time instances if the UL measurement message is according to the above criteria. Similar criteria for it applies as within the first embodiment.

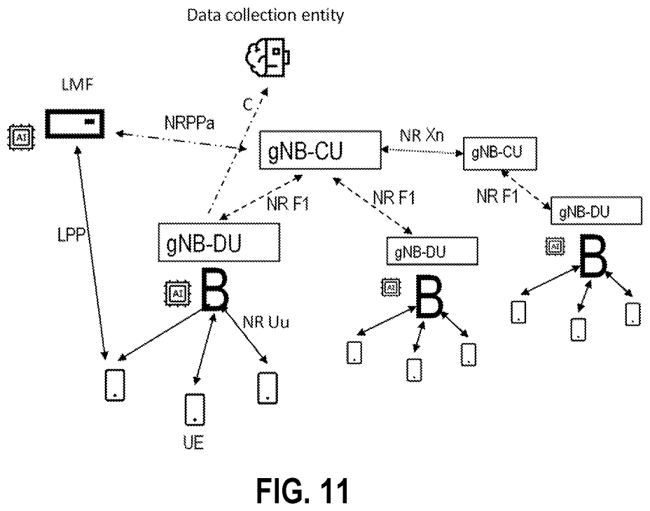

Embodiments associated with collection of data from gNB-DU are described below and an example is illustrated in FIG. 11.

In some embodiments, the data collection for the AI/ML model training is performed via the gNB-DU. The basic principle is that the gNB-DU collects and store measurement data directly. The stored data is corresponding to the can be any of data types in UL measurement message. Similar criteria for it applies as within the first embodiment.

Further the gNB-DU receives the ground-truth message or messages from the LMF on the NRPPa via the gNB-CU and forward this on the F1 interface to the gNB-DU.

The gNB-DU combines the content of the two above set of messages and send the content to the data collection entity over the C interface. It should be understood here that there can be some uncertainty in the timestamping between the UE and gNB. Hence the gNB-DU can try to match this as good as possible. After which the gNB-DU will provide the “data collection entity message” on the interface C to a data collection entity. Similar criteria for it applies as within the first embodiment.

In another example, if the ground truth label is an intermediary measurement (e.g., ToA, TDoA, AoA) that corresponds to the ML output of AI/ML assisted positioning methods, the data collection entity obtains the data of ground truth label from gNB-DU and match it with the measurement data. The gNB-DU can do so for multiple UEs and multiple time instances if the “gNB measurement message” is according to these criteria's. Instead just provide this towards to the data collection entity and without collecting information from the LMF.

It is observed that both the LMF, data collection entity, gNB-CU and gNB-DU can be operated on the same piece of physical hardware. It can be further observed that any combination of operation on multiple hardware is possible between the different entities, i.e.

LMF, data collection entity, gNB-CU and gNB-DU.

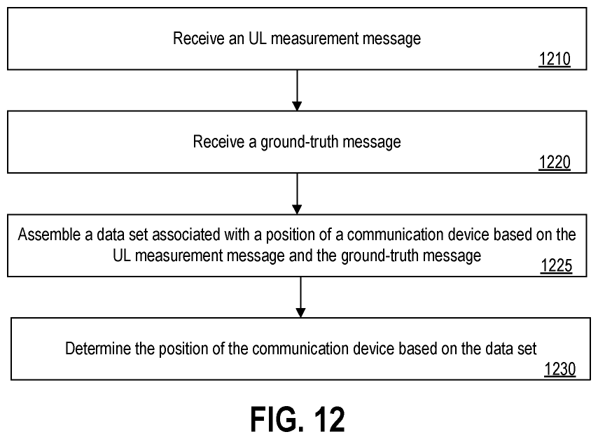

Operations of the RAN node 1500 (implemented using the structure of FIG. 15) will now be discussed with reference to the flow chart of FIG. 12 according to some embodiments of inventive concepts. For example, modules may be stored in memory 1504 of FIG. 15, and these modules may provide instructions so that when the instructions of a module are executed by respective RAN node processing circuitry 1502, RAN node 1500 performs respective operations of the flow chart.

FIG. 12 illustrates examples of operations performed by an entity in a communications network.

At block 1210, processing circuitry 1502 receives, via communication interface 1506, an UL measurement message from a first network node. In some embodiments, the first network node includes at least one of: a radio access network, RAN, node; a core network, CN, node; a central unit, CU; a distributed unit, DU; and a location management function, LMF.

In additional or alternative embodiments, the UL measurement message includes at least one of: information associated with the communication device; information associated with a plurality of communication devices; information associated with a time instance; and information associated with a plurality of time instances.

In additional or alternative embodiments, the UL measurement message includes at least one of: identification information associated with the communication device; an indication of a sounding reference signal, SRS, configuration used by the communication device to transmit the SRS; an indication of a SRS measurement; a quality indicator of the SRS measurement; and a timestamp for the SRS.

In some examples, the SRS measurement includes at least one of: channel impulse response, CIR, of the SRS; time of arrival, ToA, of the SRS; uplink received time of arrival, UL-RTOA, of the SRS; time difference of arrival, TDoA, of the SRS; angle of departure, AoD, of the SRS; angel of arrival, AoA, of the SRS; received reference signal power, RSRP, of the SRS; and received reference signal path power, RSRPP, of the SRS.

In additional or alternative examples, the SRS measurement includes at least one of:
estimated channel by the network node; path list of the SRS; carrier phase difference; round-trip time, RTT, measurement; and cell identifier, ID, of an entity that performed the measurement.

At block 1220, processing circuitry 1502 receives, via communication interface 1506, a ground-truth message from a second network node. In some embodiments, the second network node includes at least one of: a radio access network, RAN, node; a core network, CN, node; a central unit, CU; a distributed unit, DU; and a location management function, LMF.

In additional or alternative embodiments, the second network node is the first network node. In additional or alternative embodiments, the second network node is separate and independent form the first network node.

In additional or alternative embodiments, the ground-truth message includes at least one of: information associated with a communication device; information associated with a plurality of communication devices; information associated with a time instance; and information associated with a plurality of time instances.

In some examples, the ground-truth message includes at least one of: identification information associated with the communication device; an indication of position information associated with the communication device; and a timestamp.

In additional or alternative examples, the position information includes at least one of: time of arrival, ToA, of a downlink DL, signal or an uplink, UL, signal; unobserved ToA; time difference of arrival, TDoA, of the DL signal or the UL signal; unobserved TDoA; DL or UL angle of departure, AoD; DL or UL angle of arrival, AoA; received reference signal power, RSRP, of the DL signal or the UL signal; cell identifier, ID, and transmission reception point, TRP; carrier phase difference; and round-trip time, RTT, measurement.

At block 1225, processing circuitry 1502 assembles a data set associated with a position of a communication device based on the UL measurement message and the ground-truth message. In some embodiments, assembling the data set includes associating information from the UL measurement message associated with the communication device and information from the ground-truth message associated with the communication device. In additional or alternative embodiments, assembling the data set includes generating or forming the data set by combining, matching, collecting, or otherwise assembling data set from different types and/or sources of data.

At block 1230, processing circuitry 1502 determines the position of the communication device based on the data set. In some embodiments, determining the position of the communication device includes providing the data set to a machine learning model.

Various operations from the flow chart of FIG. 12 may be optional with respect to some embodiments of RAN nodes and related methods.

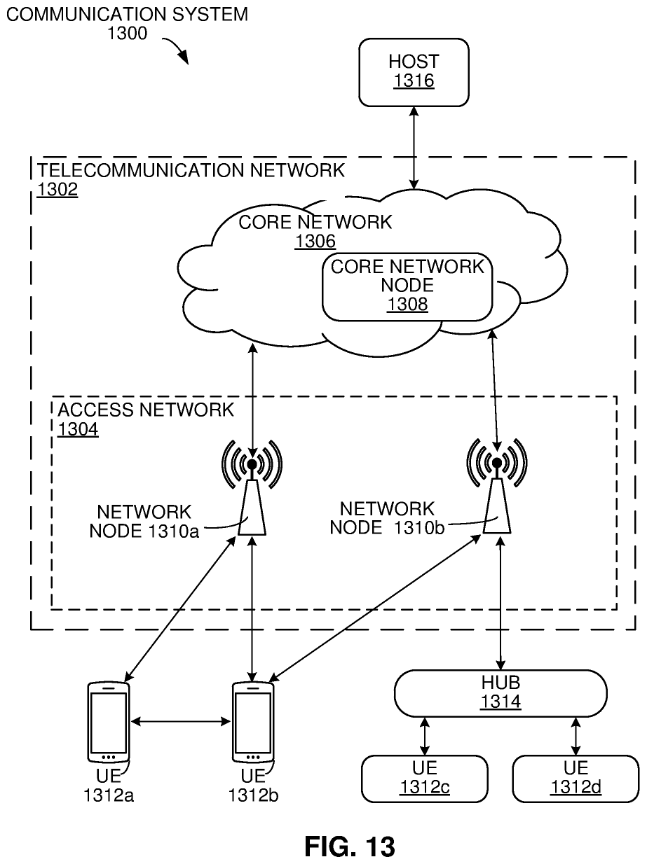

Although FIG. 12 is described in regards to a RAN node, any suitable network node may perform the operations. For example, the operations may be performed by the Core Network CN node 1500 (implemented using the structure of FIG. 15) FIG. 13 shows an example of a communication system 1300 in accordance with some embodiments.

In the example, the communication system 1300 includes a telecommunication network 1302 that includes an access network 1304, such as a radio access network (RAN), and a core network 1306, which includes one or more core network nodes 1308. The access network 1304 includes one or more access network nodes, such as network nodes 1310a and 1310b (one or more of which may be generally referred to as network nodes 1310), or any other similar 3rd Generation Partnership Project (3GPP) access node or non-3GPP access point. The network nodes 1310 facilitate direct or indirect connection of user equipment (UE), such as by connecting UEs 1312a, 1312b, 1312c, and 1312d (one or more of which may be generally referred to as UEs 1312) to the core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1300 may include any number of wired or wireless networks, network nodes, UEs, and/or any other components or systems that may facilitate or participate in the communication of data and/or signals whether via wired or wireless connections. The communication system 1300 may include and/or interface with any type of communication, telecommunication, data, cellular, radio network, and/or other similar type of system.

The UEs 1312 may be any of a wide variety of communication devices, including wireless devices arranged, configured, and/or operable to communicate wirelessly with the network nodes 1310 and other communication devices. Similarly, the network nodes 1310 are arranged, capable, configured, and/or operable to communicate directly or indirectly with the UEs 1312 and/or with other network nodes or equipment in the telecommunication network 1302 to enable and/or provide network access, such as wireless network access, and/or to perform other functions, such as administration in the telecommunication network 1302.

In the depicted example, the core network 1306 connects the network nodes 1310 to one or more hosts, such as host 1316. These connections may be direct or indirect via one or more intermediary networks or devices. In other examples, network nodes may be directly coupled to hosts. The core network 1306 includes one more core network nodes (e.g., core network node 1308) that are structured with hardware and software components. Features of these components may be substantially similar to those described with respect to the UEs, network nodes, and/or hosts, such that the descriptions thereof are generally applicable to the corresponding components of the core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1316 may be under the ownership or control of a service provider other than an operator or provider of the access network 1304 and/or the telecommunication network 1302, and may be operated by the service provider or on behalf of the service provider. The host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G);

wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1302 is a cellular network that implements 3GPP standardized features. Accordingly, the telecommunications network 1302 may support network slicing to provide different logical networks to different devices that are connected to the telecommunication network 1302. For example, the telecommunications network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1312 are configured to transmit and/or receive information without direct human interaction. For instance, a UE may be designed to transmit information to the access network 1304 on a predetermined schedule, when triggered by an internal or external event, or in response to requests from the access network 1304. Additionally, a UE may be configured for operating in single-or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1314 communicates with the access network 1304 to facilitate indirect communication between one or more UEs (e.g., UE 1312c and/or 1312d) and network nodes (e.g., network node 1310b). In some examples, the hub 1314 may be a controller, router, content source and analytics, or any of the other communication devices described herein regarding UEs. For example, the hub 1314 may be a broadband router enabling access to the core network 1306 for the UEs. As another example, the hub 1314 may be a controller that sends commands or instructions to one or more actuators in the UEs. Commands or instructions may be received from the UEs, network nodes 1310, or by executable code, script, process, or other instructions in the hub 1314. As another example, the hub 1314 may be a data collector that acts as temporary storage for UE data and, in some embodiments, may perform analysis or other processing of the data. As another example, the hub 1314 may be a content source. For example, for a UE that is a VR headset, display, loudspeaker or other media delivery device, the hub 1314 may retrieve VR assets, video, audio, or other media or data related to sensory information via a network node, which the hub 1314 then provides to the UE either directly, after performing local processing, and/or after adding additional local content. In still another example, the hub 1314 acts as a proxy server or orchestrator for the UEs, in particular in if one or more of the UEs are low energy IoT devices.

The hub 1314 may have a constant/persistent or intermittent connection to the network node 1310b. The hub 1314 may also allow for a different communication scheme and/or schedule between the hub 1314 and UEs (e.g., UE 1312c and/or 1312d), and between the hub 1314 and the core network 1306. In other examples, the hub 1314 is connected to the core network 1306 and/or one or more UEs via a wired connection. Moreover, the hub 1314 may be configured to connect to an M2M service provider over the access network 1304 and/or to another UE over a direct connection. In some scenarios, UEs may establish a wireless connection with the network nodes 1310 while still connected via the hub 1314 via a wired or wireless connection. In some embodiments, the hub 1314 may be a dedicated hub-that is, a hub whose primary function is to route communications to/from the UEs from/to the network node 1310b. In other embodiments, the hub 1314 may be a non-dedicated hub-that is, a device which is capable of operating to route communications between the UEs and network node 1310b, but which is additionally capable of operating as a communication start and/or end point for certain data channels.

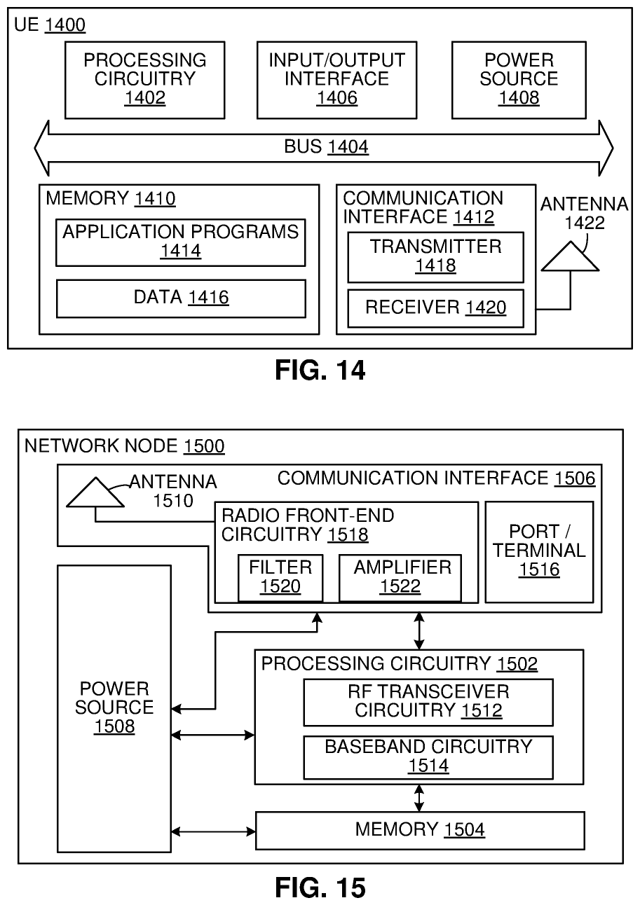

FIG. 14 shows a UE 1400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller).

Alternatively, a UE may represent a device that is not intended for sale to, or operation by, an end user but which may be associated with or operated for the benefit of a user (e.g., a smart power meter).

The UE 1400 includes processing circuitry 1402 that is operatively coupled via a bus 1404 to an input/output interface 1406, a power source 1408, a memory 1410, a communication interface 1412, and/or any other component, or any combination thereof. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

The processing circuitry 1402 is configured to process instructions and data and may be configured to implement any sequential state machine operative to execute instructions stored as machine-readable computer programs in the memory 1410. The processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1402 may include multiple central processing units (CPUs).

In the example, the input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1408 is structured as a battery or battery pack. Other types of power sources, such as an external power source (e.g., an electricity outlet), photovoltaic device, or power cell, may be used. The power source 1408 may further include power circuitry for delivering power from the power source 1408 itself, and/or an external power source, to the various parts of the UE 1400 via input circuitry or an interface such as an electrical power cable. Delivering power may be, for example, for charging of the power source 1408. Power circuitry may perform any formatting, converting, or other modification to the power from the power source 1408 to make the power suitable for the respective components of the UE 1400 to which power is supplied.

The memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1410 includes one or more application programs 1414, such as an operating system, web browser application, a widget, gadget engine, or other application, and corresponding data 1416. The memory 1410 may store, for use by the UE 1400, any of a variety of various operating systems or combinations of operating systems.

The memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1410 may allow the UE 1400 to access instructions, application programs and the like, stored on transitory or non-transitory memory media, to off-load data, or to upload data. An article of manufacture, such as one utilizing a communication system may be tangibly embodied as or in the memory 1410, which may be or comprise a device-readable storage medium.

The processing circuitry 1402 may be configured to communicate with an access network or other network using the communication interface 1412. The communication interface 1412 may comprise one or more communication subsystems and may include or be communicatively coupled to an antenna 1422. The communication interface 1412 may include one or more transceivers used to communicate, such as by communicating with one or more remote transceivers of another device capable of wireless communication (e.g., another UE or a network node in an access network). Each transceiver may include a transmitter 1418 and/or a receiver 1420 appropriate to provide network communications (e.g., optical, electrical, frequency allocations, and so forth). Moreover, the transmitter 1418 and receiver 1420 may be coupled to one or more antennas (e.g., antenna 1422) and may share circuit components, software or firmware, or alternatively be implemented separately.

In the illustrated embodiment, communication functions of the communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IOT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IOT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1500 includes a processing circuitry 1502, a memory 1504, a communication interface 1506, and a power source 1508. The network node 1500 may be composed of multiple physically separate components (e.g., a NodeB component and a RNC component, or a BTS component and a BSC component, etc.), which may each have their own respective components. In certain scenarios in which the network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1500 may be configured to support multiple radio access technologies (RATs). In such embodiments, some components may be duplicated (e.g., separate memory 1504 for different RATs) and some components may be reused (e.g., a same antenna 1510 may be shared by different RATs). The network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

The processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as the memory 1504, to provide network node 1500 functionality.

In some embodiments, the processing circuitry 1502 includes a system on a chip (SOC). In some embodiments, the processing circuitry 1502 includes one or more of radio frequency (RF) transceiver circuitry 1512 and baseband processing circuitry 1514. In some embodiments, the radio frequency (RF) transceiver circuitry 1512 and the baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

The memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1502. The memory 1504 may store any suitable instructions, data, or information, including a computer program, software, an application including one or more of logic, rules, code, tables, and/or other instructions capable of being executed by the processing circuitry 1502 and utilized by the network node 1500. The memory 1504 may be used to store any calculations made by the processing circuitry 1502 and/or any data received via the communication interface 1506. In some embodiments, the processing circuitry 1502 and memory 1504 is integrated.

The communication interface 1506 is used in wired or wireless communication of signaling and/or data between a network node, access network, and/or UE. As illustrated, the communication interface 1506 comprises port(s)/terminal(s) 1516 to send and receive data, for example to and from a network over a wired connection. The communication interface 1506 also includes radio front-end circuitry 1518 that may be coupled to, or in certain embodiments a part of, the antenna 1510. Radio front-end circuitry 1518 comprises filters 1520 and amplifiers 1522. The radio front-end circuitry 1518 may be connected to an antenna 1510 and processing circuitry 1502. The radio front-end circuitry may be configured to condition signals communicated between antenna 1510 and processing circuitry 1502. The radio front-end circuitry 1518 may receive digital data that is to be sent out to other network nodes or UEs via a wireless connection. The radio front-end circuitry 1518 may convert the digital data into a radio signal having the appropriate channel and bandwidth parameters using a combination of filters 1520 and/or amplifiers 1522. The radio signal may then be transmitted via the antenna 1510.

Similarly, when receiving data, the antenna 1510 may collect radio signals which are then converted into digital data by the radio front-end circuitry 1518. The digital data may be passed to the processing circuitry 1502. In other embodiments, the communication interface may comprise different components and/or different combinations of components.

In certain alternative embodiments, the network node 1500 does not include separate radio front-end circuitry 1518, instead, the processing circuitry 1502 includes radio front-end circuitry and is connected to the antenna 1510. Similarly, in some embodiments, all or some of the RF transceiver circuitry 1512 is part of the communication interface 1506. In still other embodiments, the communication interface 1506 includes one or more ports or terminals 1516, the radio front-end circuitry 1518, and the RF transceiver circuitry 1512, as part of a radio unit (not shown), and the communication interface 1506 communicates with the baseband processing circuitry 1514, which is part of a digital unit (not shown).

The antenna 1510 may include one or more antennas, or antenna arrays, configured to send and/or receive wireless signals. The antenna 1510 may be coupled to the radio front-end circuitry 1518 and may be any type of antenna capable of transmitting and receiving data and/or signals wirelessly. In certain embodiments, the antenna 1510 is separate from the network node 1500 and connectable to the network node 1500 through an interface or port.

The antenna 1510, communication interface 1506, and/or the processing circuitry 1502 may be configured to perform any receiving operations and/or certain obtaining operations described herein as being performed by the network node. Any information, data and/or signals may be received from a UE, another network node and/or any other network equipment.

Similarly, the antenna 1510, the communication interface 1506, and/or the processing circuitry 1502 may be configured to perform any transmitting operations described herein as being performed by the network node. Any information, data and/or signals may be transmitted to a UE, another network node and/or any other network equipment.

The power source 1508 provides power to the various components of network node 1500 in a form suitable for the respective components (e.g., at a voltage and current level needed for each respective component). The power source 1508 may further comprise, or be coupled to, power management circuitry to supply the components of the network node 1500 with power for performing the functionality described herein. For example, the network node 1500 may be connectable to an external power source (e.g., the power grid, an electricity outlet) via an input circuitry or interface such as an electrical cable, whereby the external power source supplies power to power circuitry of the power source 1508. As a further example, the power source 1508 may comprise a source of power in the form of a battery or battery pack which is connected to, or integrated in, power circuitry. The battery may provide backup power should the external power source fail.

Embodiments of the network node 1500 may include additional components beyond those shown in FIG. 15 for providing certain aspects of the network node's functionality, including any of the functionality described herein and/or any functionality necessary to support the subject matter described herein. For example, the network node 1500 may include user interface equipment to allow input of information into the network node 1500 and to allow output of information from the network node 1500. This may allow a user to perform diagnostic, maintenance, repair, and other administrative functions for the network node 1500.

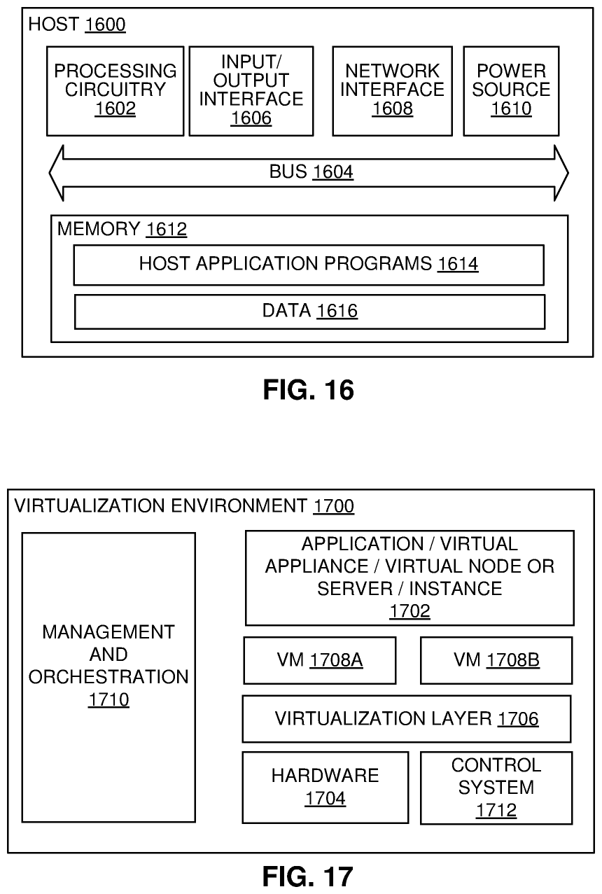

FIG. 16 is a block diagram of a host 1600, which may be an embodiment of the host 1316 of FIG. 13, in accordance with various aspects described herein. As used herein, the host 1600 may be or comprise various combinations hardware and/or software, including a standalone server, a blade server, a cloud-implemented server, a distributed server, a virtual machine, container, or processing resources in a server farm. The host 1600 may provide one or more services to one or more UEs.

The host 1600 includes processing circuitry 1602 that is operatively coupled via a bus 1604 to an input/output interface 1606, a network interface 1608, a power source 1610, and a memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

The memory 1612 may include one or more computer programs including one or more host application programs 1614 and data 1616, which may include user data, e.g., data generated by a UE for the host 1600 or data generated by the host 1600 for a UE. Embodiments of the host 1600 may utilize only a subset or all of the components shown. The host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1614 may also provide for user authentication and licensing checks and may periodically report health, routes, and content availability to a central node, such as a device in or on the edge of a core network. Accordingly, the host 1600 may select and/or indicate a different host for over-the-top (OTT) services for a UE. The host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a and 1708b (one or more of which may be generally referred to as VMs 1708), and/or perform any of the functions, features and/or benefits described in relation with some embodiments described herein. The virtualization layer 1706 may present a virtual operating platform that appears like networking hardware to the VMs 1708.

The VMs 1708 comprise virtual processing, virtual memory, virtual networking or interface and virtual storage, and may be run by a corresponding virtualization layer 1706.

Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1708 may be a software implementation of a physical machine that runs programs as if they were executing on a physical, non-virtualized machine.

Each of the VMs 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1708 on top of the hardware 1704 and corresponds to the application 1702.

Hardware 1704 may be implemented in a standalone network node with generic or specific components. Hardware 1704 may implement some functions via virtualization.

Alternatively, hardware 1704 may be part of a larger cluster of hardware (e.g. such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1712 which may alternatively be used for communication between hardware nodes and radio units.

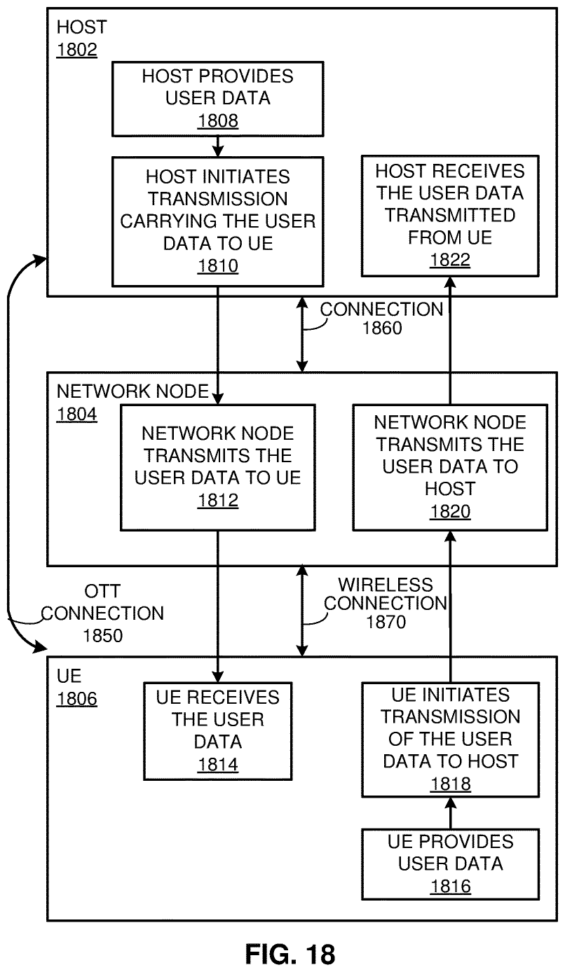

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. The host 1802 also includes software, which is stored in or accessible by the host 1802 and executable by the processing circuitry. The software includes a host application that may be operable to provide a service to a remote user, such as the UE 1806 connecting via an over-the-top (OTT) connection 1850 extending between the UE 1806 and host 1802. In providing the service to the remote user, a host application may provide user data which is transmitted using the OTT connection 1850.

The network node 1804 includes hardware enabling it to communicate with the host 1802 and UE 1806. The connection 1860 may be direct or pass through a core network (like core network 1306 of FIG. 13) and/or one or more other intermediate networks, such as one or more public, private, or hosted networks. For example, an intermediate network may be a backbone network or the Internet.

The UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of the host 1802. In the host 1802, an executing host application may communicate with the executing client application via the OTT connection 1850 terminating at the UE 1806 and host 1802. In providing the service to the user, the UE's client application may receive request data from the host's host application and provide user data in response to the request data. The OTT connection 1850 may transfer both the request data and the user data. The UE's client application may interact with the user to generate the user data that it provides to the host application through the OTT connection 1850.

The OTT connection 1850 may extend via a connection 1860 between the host 1802 and the network node 1804 and via a wireless connection 1870 between the network node 1804 and the UE 1806 to provide the connection between the host 1802 and the UE 1806. The connection 1860 and wireless connection 1870, over which the OTT connection 1850 may be provided, have been drawn abstractly to illustrate the communication between the host 1802 and the UE 1806 via the network node 1804, without explicit reference to any intermediary devices and the precise routing of messages via these devices.

As an example of transmitting data via the OTT connection 1850, in step 1808, the host 1802 provides user data, which may be performed by executing a host application. In some embodiments, the user data is associated with a particular human user interacting with the UE 1806. In other embodiments, the user data is associated with a UE 1806 that shares data with the host 1802 without explicit human interaction. In step 1810, the host 1802 initiates a transmission carrying the user data towards the UE 1806. The host 1802 may initiate the transmission responsive to a request transmitted by the UE 1806. The request may be caused by human interaction with the UE 1806 or by operation of the client application executing on the UE 1806. The transmission may pass via the network node 1804, in accordance with the teachings of the embodiments described throughout this disclosure. Accordingly, in step 1812, the network node 1804 transmits to the UE 1806 the user data that was carried in the transmission that the host 1802 initiated, in accordance with the teachings of the embodiments described throughout this disclosure. In step 1814, the UE 1806 receives the user data carried in the transmission, which may be performed by a client application executed on the UE 1806 associated with the host application executed by the host 1802.

In some examples, the UE 1806 executes a client application which provides user data to the host 1802. The user data may be provided in reaction or response to the data received from the host 1802. Accordingly, in step 1816, the UE 1806 may provide user data, which may be performed by executing the client application. In providing the user data, the client application may further consider user input received from the user via an input/output interface of the UE 1806. Regardless of the specific manner in which the user data was provided, the UE 1806 initiates, in step 1818, transmission of the user data towards the host 1802 via the network node 1804. In step 1820, in accordance with the teachings of the embodiments described throughout this disclosure, the network node 1804 receives user data from the UE 1806 and initiates transmission of the received user data towards the host 1802. In step 1822, the host 1802 receives the user data carried in the transmission initiated by the UE 1806.

One or more of the various embodiments improve the performance of OTT services provided to the UE 1806 using the OTT connection 1850, in which the wireless connection 1870 forms the last segment. More precisely, the teachings of these embodiments may improve data rate and/or latency and thereby provide benefits such as reduced user waiting, better responsiveness, and improved user experience.

In an example scenario, factory status information may be collected and analyzed by the host 1802. As another example, the host 1802 may process audio and video data which may have been retrieved from a UE for use in creating maps. As another example, the host 1802 may collect and analyze real-time data to assist in controlling vehicle congestion (e.g., controlling traffic lights). As another example, the host 1802 may store surveillance video uploaded by a UE. As another example, the host 1802 may store or control access to media content such as video, audio, VR or AR which it can broadcast, multicast or unicast to UEs. As other examples, the host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1850 between the host 1802 and UE 1806, in response to variations in the measurement results. The measurement procedure and/or the network functionality for reconfiguring the OTT connection may be implemented in software and hardware of the host 1802 and/or UE 1806. In some embodiments, sensors (not shown) may be deployed in or in association with other devices through which the OTT connection 1850 passes; the sensors may participate in the measurement procedure by supplying values of the monitored quantities exemplified above, or supplying values of other physical quantities from which software may compute or estimate the monitored quantities. The reconfiguring of the OTT connection 1850 may include message format, retransmission settings, preferred routing etc.; the reconfiguring need not directly alter the operation of the network node 1804. Such procedures and functionalities may be known and practiced in the art. In certain embodiments, measurements may involve proprietary UE signaling that facilitates measurements of throughput, propagation times, latency and the like, by the host 1802. The measurements may be implemented in that software causes messages to be transmitted, in particular empty or ‘dummy’ messages, using the OTT connection 1850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein.

Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Example Embodiments are described below.

Embodiment 1. A method of operating an entity in a communications network, the method comprising:
receiving (1210) an uplink, UL, measurement message from a first network node;
receiving (1220) a ground-truth message from a second network node; and
determining (1230) a position of a communication device based on the UL measurement message and the ground-truth message.

Embodiment 2. The method of Embodiment 1, wherein the first network node comprises at least one of:
a radio access network, RAN, node;
a core network, CN, node;
a central unit, CU;
a distributed unit, DU; and
a location management function, LMF.

Embodiment 3. The method of any of Embodiments 1-2, wherein the second network node comprises at least one of:
a radio access network, RAN, node;
a core network, CN, node;
a central unit, CU;
a distributed unit, DU; and
a location management function, LMF.

Embodiment 4. The method of any of Embodiments 1-3, wherein the second network node is the first network node.

Embodiment 5. The method of any of Embodiments 1-3, wherein the second network node is separate and independent form the first network node.

Embodiment 6. The method of any of Embodiments 1-5, wherein the UL measurement message comprises at least one of:
information associated with the communication device;
information associated with a plurality of communication devices;
information associated with a time instance; and
information associated with a plurality of time instances.

Embodiment 7. The method of any of Embodiments 6, wherein the UL measurement message comprises at least one of:
identification information associated with the communication device;
an indication of a sounding reference signal, SRS, configuration used by the communication device to transmit the SRS;
an indication of a SRS measurement;
a quality indicator of the SRS measurement; and
a timestamp for the SRS.

Embodiment 8. The method of Embodiment 7, wherein the SRS measurement comprises at least one of:
channel impulse response, CIR, of the SRS;
time of arrival, ToA, of the SRS;
uplink received time of arrival, UL-RTOA, of the SRS;
time difference of arrival, TDoA, of the SRS;
angle of departure, AoD, of the SRS;
angel of arrival, AoA, of the SRS;
received reference signal power, RSRP, of the SRS; and
received reference signal path power, RSRPP, of the SRS.

Embodiment 9. The method of Embodiment 7, wherein the SRS measurement comprises at least one of:
estimated channel by the network node;
path list of the SRS;
carrier phase difference;
round-trip time, RTT, measurement; and
cell identifier, ID, of an entity that performed the measurement.

Embodiment 10. The method of any of Embodiments 1-9, wherein the ground-truth message comprises at least one of:
information associated with a communication device;
information associated with a plurality of communication devices;
information associated with a time instance; and
information associated with a plurality of time instances.

Embodiment 11. The method of any of Embodiments 10, wherein the ground-truth message comprises at least one of:
identification information associated with the communication device;
an indication of position information associated with the communication device; and
a timestamp.

Embodiment 12. The method of Embodiment 11, wherein the position information comprises at least one of:
time of arrival, ToA, of a downlink DL, signal or an uplink, UL, signal;
unobserved ToA;
time difference of arrival, TDoA, of the DL signal or the UL signal;
unobserved TDoA;
DL or UL angle of departure, AoD;
DL or UL angle of arrival, AoA;
received reference signal power, RSRP, of the DL signal or the UL signal;
cell identifier, ID, and transmission reception point, TRP;
carrier phase difference; and
round-trip time, RTT, measurement.

Embodiment 13. A network node (1500) in a communications network that includes communication device, the entity comprising:
processing circuitry (1502); and
memory (1504) coupled to the processing circuitry and having instructions stored therein that are executable by the processing circuitry to cause the entity to perform operations comprising any of the operations of Embodiments 1-12.

Embodiment 14. A computer program comprising program code to be executed by processing circuitry (1502) of a network node (1500) in a communications network that includes communication device, whereby execution of the program code causes the entity to perform operations comprising any operations of Embodiments 1-12.

Embodiment 15. A computer program product comprising a non-transitory storage medium (1504) including program code to be executed by processing circuitry (1502) of a network node (1500) in a communications network that includes a communication device, whereby execution of the program code causes the entity to perform operations comprising any operations of Embodiments 1-12.

Embodiment 16. A non-transitory computer-readable medium having instructions stored therein that are executable by processing circuitry (1502) of a network node (1500) configured to perform operations comprising any of the operations of Embodiments 1-12.

Embodiment 17. A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform the following operations to transmit the user data from the host to the UE:
   receiving (1210) an uplink, UL, measurement message from a first network node;
receiving (1220) a ground-truth message from a second network node; and
   determining (1230) a position of a communication device based on the UL measurement message and the ground-truth message.

Embodiment 18. The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 19. A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs the following operations to transmit the user data from the host to the UE:
   receiving (1210) an uplink, UL, measurement message from a first network node;
   receiving (1220) a ground-truth message from a second network node; and
determining (1230) a position of a communication device based on the UL measurement message and the ground-truth message.

Embodiment 20. The method of the previous embodiment, further comprising, at the network node, transmitting the user data provided by the host for the UE.

Embodiment 21. The method of any of the previous 2 embodiments, wherein the user data is provided at the host by executing a host application that interacts with a client application executing on the UE, the client application being associated with the host application.

Embodiment 22. A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform the following operations to transmit the user data from the host to the UE:
   receiving (1210) an uplink, UL, measurement message from a first network node;
   receiving (1220) a ground-truth message from a second network node; and
determining (1230) a position of a communication device based on the UL measurement message and the ground-truth message.

Embodiment 23. The communication system of the previous embodiment, further comprising:
the network node; and/or
the user equipment.

Embodiment 24. The communication system of the previous 2 embodiments, wherein:
the processing circuitry of the host is configured to execute a host application, thereby providing the user data; and
the host application is configured to interact with a client application executing on the UE, the client application being associated with the host application.

Embodiment 25. A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform the following operations to receive the user data from the UE for the host:
   receiving (1210) an uplink, UL, measurement message from a first network node;
   receiving (1220) a ground-truth message from a second network node; and
   determining (1230) a position of a communication device based on the UL measurement message and the ground-truth message.

Embodiment 26. The host of the previous 2 embodiments, wherein:
the processing circuitry of the host is configured to execute a host application, thereby providing the user data; and
the host application is configured to interact with a client application executing on the UE, the client application being associated with the host application.

Embodiment 27. The host of the any of the previous 2 embodiments, wherein the initiating receipt of the user data comprises requesting the user data.

Embodiment 28. A method implemented by a host configured to operate in a communication system that further includes a network node and a user equipment (UE), the method comprising:
at the host, initiating receipt of user data from the UE, the user data originating from a transmission which the network node has received from the UE, wherein the network node performs the following operations to receive the user data from the UE for the host:
   receiving (1210) an uplink, UL, measurement message from a first network node;
   receiving (1220) a ground-truth message from a second network node; and
determining (1230) a position of a communication device based on the UL measurement message and the ground-truth message.

Embodiment 29. The method of the previous embodiment, further comprising at the network node, transmitting the received user data to the host.

1. A method of operating an entity in a communications network, the method comprising:
receiving an uplink, UL, measurement message from a first network node;
receiving a ground-truth message from a second network node; and
assembling a data set associated with a position of a communication device based on the UL measurement message and the ground-truth message.

2. The method of claim 1, further comprising:
determining the position of the communication device based on the data set.

3. The method of claim 1, wherein the first network node comprises at least one of:
a radio access network, RAN, node;
a core network, CN, node;
a central unit, CU;
a distributed unit, DU; and
a location management function, LMF.

4. The method of claim 1, wherein the second network node comprises at least one of:
a radio access network, RAN, node;
a core network, CN, node;
a central unit, CU;
a distributed unit, DU; and
a location management function, LMF.

5. The method of claim 1, wherein the second network node is the first network node.

6. The method of claim 1, wherein the second network node is separate and independent form the first network node.

7. The method of claim 1, wherein the UL measurement message comprises at least one of:
information associated with the communication device;
information associated with a plurality of communication devices;
information associated with a time instance; and
information associated with a plurality of time instances.

8. The method of claim 7, wherein the UL measurement message comprises at least one of:
identification information associated with the communication device;
an indication of a sounding reference signal, SRS, configuration used by the communication device to transmit the SRS;
an indication of a SRS measurement;
a quality indicator of the SRS measurement; and
a timestamp for the SRS.

9. The method of claim 8, wherein the SRS measurement comprises at least one of:
channel impulse response, CIR, of the SRS;
time of arrival, ToA, of the SRS;
uplink received time of arrival, UL-RTOA, of the SRS;
time difference of arrival, TDoA, of the SRS;
angle of departure, AoD, of the SRS;
angel of arrival, AoA, of the SRS;
received reference signal power, RSRP, of the SRS; and
received reference signal path power, RSRPP, of the SRS.

10. The method of claim 8, wherein the SRS measurement comprises at least one of:
estimated channel by the network node;
path list of the SRS;
carrier phase difference;
round-trip time, RTT, measurement; and
cell identifier, ID, of an entity that performed the measurement.

11. The method of claim 1, wherein the ground-truth message comprises at least one of:
information associated with a communication device;
information associated with a plurality of communication devices;
information associated with a time instance; and
information associated with a plurality of time instances.

12. The method of claim 11, wherein the ground-truth message comprises at least one of:
identification information associated with the communication device; and
a timestamp.

13. The method of claim 11, wherein the ground-truth message comprises an indication of position information associated with the communication device.

14. The method of claim 13, wherein the position information comprises at least one of:
a time of arrival, ToA, of a downlink, DL, signal;
a ToA of an uplink, UL, signal; and
an unobserved ToA.

15. The method of claim 13, wherein the position information comprises at least one of:
a time difference of arrival, TDoA, of the DL signal;
a TDoA of the UL signal; and
an unobserved TDoA.

16. The method of claim 13, wherein the position information comprises at least one of:
a DL angle of departure, AoD;
an UL AoD;
a DL angle of arrival, AoA; and
an UL AoA.

17. The method of claim 13, wherein the position information comprises at least one of:
a received reference signal power, RSRP, of the DL signal; and
a RSRP of the UL signal.

18. The method of claim 13, wherein the position information comprises at least one of:
a cell identifier, ID, and transmission reception point, TRP;
a carrier phase difference; and
a round-trip time, RTT, measurement.

19. A network node configured to perform operations comprising:
receiving an uplink, UL, measurement message from a first network node;
receiving a ground-truth message from a second network node; and
assembling a data set associated with a position of a communication device based on the UL measurement message and the ground-truth message.

20. The network node of claim 19, the operations further comprising determining the position of the communication device based on the data set.

21. (canceled)

22. (canceled)

23. A computer program product comprising a non-transitory storage medium including program code to be executed by processing circuitry of a network node in a communications network that includes a communication device, whereby execution of the program code causes the entity to perform operations comprising:
receiving an uplink, UL, measurement message from a first network node;
receiving a ground-truth message from a second network node; and
assembling a data set associated with a position of a communication device based on the UL measurement message and the ground-truth message.

24. The computer program product of claim 23, the operations further comprising determining the position of the communication device based on the data set.
